(19) United States
(12) Patent Application Publication
(10) Pub. No.: US 2015/0302388 A1
(43) Pub. Date: Oct. 22, 2015

(54) Design framework and apparatus for paying gratitudes

(71) Applicants: Glenn Robert Seidman, Woodside, CA (US); Denise Anne Holt, Pleasanton, CA (US); Rajesh A Patel, Redwood City, CA (US); Ragin Thakorbhai Desai, San Jose, CA (US)

(72) Inventors: Glenn Robert Seidman, Woodside, CA (US); Denise Anne Holt, Pleasanton, CA (US); Rajesh A Patel, Redwood City, CA (US); Ragin Thakorbhai Desai, San Jose, CA (US)

(73) Assignee: Gratzeez, LLC, Redwood City, CA (US)

(21) Appl. No.: 14/545,273

(22) Filed: Apr. 15, 2015

Related U.S. Application Data
(60) Provisional application No. 61/980,583, filed on Apr. 17, 2014.

(51) Int. Cl. G06Q 20/32; G06Q 20/22; G06Q 30/02; G06Q 40/00; G06Q 30/06

(52) U.S. Cl. CPC G06Q 20/3224; G06Q 40/125; G06Q 30/0631; G06Q 30/0279; G06Q 20/29; G06Q 30/0282

(57) ABSTRACT

A computer-implemented method that requires an inventive special-purpose software apparatus is disclosed. The apparatus comprises software subsystems that facilitate Patrons using a Mobile Application, to easily find and then submit gratuity payments to Service Providers.

### TECHNICAL FIELD OF THE INVENTION

The present invention relates broadly to payment systems and, more particularly to payment systems that can be accessed via users' smartphones.

### BACKGROUND OF THE INVENTION

Hotels, transportation, salons, barbers, restaurants, tour guides, coffee houses, sandwich shops, food delivery, sports training, dog walkers, DJ's, florists . . . these are just a few of the hundreds of different types of service providers that patrons routinely tip. While the restaurant industry has a system in place that allows patrons to use their credit card to leave a gratuity, most industry service providers are only capable of accepting cash. When the customer doesn't have any cash—or denominations that can be used for a tip—the service provider is left with nothing.

Electronic money exchange is the foundation of a solution. However, while existing electronic money exchange services perform monetary deposits everyday via mobile phones from one person to another, there is no easy way to know who to send money to someone you meet briefly at a service location. To do so, one either requires an email address or userId for the service provider to tip. However, both the service provider and the Patron are often strangers and don't want to share contact information like email, and even if a userId is employed, it must be typed in and so the tipping process becomes cumbersome. Additionally, many service providers cannot or may not carry or use their mobile phones during performance of their services and so paying via mobile phone exchange using mobile applications is often not possible. There needs to be a way to overcome the problem of Patrons not having cash for gratuity, and service providers not having to carry mobile phones while on duty in order to interact with Patrons.

Some previous work has been documented on interacting on mobile payments and some relate to tipping. Several systems are presented below.

US 20100325048 (Carlson et al.; 2010 Dec. 23) SYSTEM AND METHOD FOR PROVIDING CONSUMER TIP ASSISTANCE AS PART OF PAYMENT TRANSACTION. Systems, apparatuses, and methods for conducting payment transactions are disclosed. In exemplary embodiments, a consumer may wish to add a tip or gratuity when paying for a good or service, such as a meal at a restaurant. Exemplary systems may generate an alert or other form of message based on the transaction, where the alert or message may include a suggested amount for a tip and/or provide the consumer with information that may be used to determine an amount for the tip. In some embodiments, the systems, apparatuses, and methods may automatically generate an estimated amount for the tip based on previously established user preferences, with the estimated amount being added to the underlying cost of the good or service when authorization is sought for the transaction.

US 20130103579 (Kessler et al.; 2013 Apr. 25) SYSTEM AND METHOD FOR COLLECTING AND DISBURSING ELECTRONIC GRATUITIES. According to one embodiment, a device for submitting gratuities by credit card is provided at a place of business or other appropriate location. A method of using this device is disclosed, whereby consumers pay a predetermined or adjustable gratuity amount by inserting a credit card into the device. According to another embodiment, technological infrastructure is provided to transmit encrypted payment information such that the acquiring bank of the device provider obtains authorization for gratuity transactions conducted using the device. The acquiring bank is thus enabled to credit the device provider's merchant account or disbursal accounts with electronic gratuity payments less acquisition fees. According to another embodiment, a method of disbursing gratuity shares to employees of the business is provided, wherein processing fees are collected by the device provider.

WO2012166359 (Flynn; 2012 Dec. 6) Electronic Commercial Transaction Systems and Methods for Soliciting and Collecting Gratuities and Donations. An electronic commercial transaction system and associated methods, in which the transaction is conducted concurrently with or followed by a solicitation for either a gratuity for the seller or a charitable donation to be forwarded to a third party beneficiary. Accordingly, there is provided, in preferred embodiments of the invention, methods and devices that include one or more of the following components: First, an option presented to an online purchaser of goods or services, including but not limited to gaming services, to make a donation to a third party beneficiary such as a charitable organization, a political candidate or a political organization. Such offer could name a single potential beneficiary or a plurality of potential beneficiaries. The casino or other online business may offer this service for free or charge a fee. Second, an option presented to an online purchaser of goods or services to pay a tip or gratuity to the online casino or business itself. In addition to online purchases, the disclosed system can also be used for purchases or gaming in which non-internet connected computer networks are utilized, either on-site at the point of purchase or otherwise. In a preferred embodiment, a machine-accessible medium having associated instructions that, when accessed, comprise a system for the electronic payment of a gratuity or donation during an electronic commercial transaction between a buyer/customer and seller, comprising the steps of: (a) offering the customer the opportunity to make an electronic gift of a certain amount of money during the course of the electronic commercial transaction by electronically presenting in a graphical user interface an option to accept or decline the electronic gift, wherein the electronic gift is intended for a beneficiary selected from the seller or an employee of the seller as a gratuity, or one or a plurality of third party beneficiaries as a donation, and (b)

electronically transmitting the electronic gift intended for the beneficiary to an account of such beneficiary. In another preferred embodiment, method of providing an electronic system for making commercial transactions via the internet or another data network, comprising the steps of the preceding paragraph.

US 20120310779 (Flynn; 2012 Dec. 6) Electronic Commercial Transaction Systems and Methods for Soliciting and Collecting Gratuities and Donations—An electronic commercial transaction system and associated methods, in which the transaction is conducted concurrently with or followed by a solicitation for either a gratuity for the seller or a charitable donation to be forwarded to a third party beneficiary.

US 20120310761 (Flynn; 2012 Jun. 4) Electronic Commercial Transaction Systems and Methods for Soliciting and Collecting Gratuities and Donations. An electronic commercial transaction system and associated methods, in which the transaction is conducted concurrently with or followed by a solicitation for either a gratuity for the seller or a charitable donation to be forwarded to a third party beneficiary.

US 20120078762 (Valin et al, 2012 Mar. 29) Method for Providing Donations to Third Parties During a Financial Transaction and Tracking the Details of the Financial Transactions For Donation Contributors and Recipients. A method for embedding a socially conscious donation, contribution, payment into a transaction at the point of sale or purchase using any payment platform that accepts, debit, credit, cash, financing, donations, contributions, financial service transactions, etc. and facilitates, separates, and keeps track of the process and the transaction, including the giveback. The system and method also handles contributions to any beneficiary which could be the person making the purchase or sale or barter. The system and method utilizes a human key to make and take requests, record payments, take and certify payments between a user or plurality of users, a merchant/business, and a charity of designated beneficiary. Whereby a set amount by the parties, user, purchaser, seller, and beneficiary can be used for a donation, contribution, or payment to a beneficiary determined at the point of sale, purchase, or barter.

U.S. Pat. No. 8,239,259 (Borst et al.; 2012 Aug. 7) Donations in a Virtual Environment. A donation aspect for a website is provided. Amounts of donations are limited and users are given awards based on their donations.

US 20090024528 (Otero; 2009 Jan. 22) Method and system for charitable fund raising in conjunction with game-of-chance participation by donors. A method for making a contribution to a charitable organization through a financial transactions device by a participant having an account with a financial institution accessible through the financial transaction device. The method comprising: (a) the participant conducting a financial transaction at the financial transactions device, the financial transaction involving the financial institution; (b) the participant solicited to make a contribution to the charitable organization through the financial transactions device; (c) the participant making the contribution by deduction from the participant's account at the financial institution; (d) crediting the contribution to an account of the charitable organization; (e) soliciting the participant to participate in a game of chance through the financial transactions device; (f) the participant selecting a game entry object or automatically receiving the game entry object; (g) closing participation in the game of chance; (h) selecting a game winning object; (i) comparing the participant's game entry object with the game winning object; (j) declaring the participant to be a winner if there is a predetermined relationship between the game entry object and the game winning object; and (k) crediting a prize amount, if any, to the participant's account.

US 20120226571 (Brown; 2012 Sep. 6) Product tracking to enable tipping of a producer. Provided herein are various techniques for monetarily tipping a producer through product tracking. An exemplary system or method constructed in accordance with techniques described in this paper can generate a computer readable reference code in association with a producer or product, wherein the computer readable reference code (e.g., barcode, image, or alphanumeric character string) once received by a computing device, is configured to cause the computing device to be directed to an interface (e.g., application or web-based interface) through which an individual can send a monetary tip to the producer. After generation, the computer readable reference code may be provided for marking on a product that is associated with the producer.

US 20070255653 (Tumminaro et al.; 2007 Nov. 1) Mobile Person-to-Person Payment System. A mobile payment platform and service provides a fast, easy way to make payments by users of mobile devices. The platform also interfaces with nonmobile channels and devices such as email, instant messenger, and Web. In an implementation, funds are accessed from an account holder's mobile device such as a mobile phone or a personal digital assistant to make or receive payments. Financial transactions can be conducted on a person-to-person (P2P) or person-to-merchant (P2M) basis where each party is identified by a unique indicator such as a telephone number or bar code. Transactions can be requested through any number of means including SMS messaging, Web, e-mail, instant messenger, a mobile client application, an instant messaging plug-in application or “widget.” The mobile client application, resident on the mobile device, simplifies access and performing financial transactions in a fast, secure manner.

US 20070255652 (Tumminaro et al.; 2007 Nov. 1) Mobile Person-to-Person Payment System. A mobile payment platform and service provides a fast, easy way to make payments by users of mobile devices. The platform also interfaces with nonmobile channels and devices such as email, instant messenger, and Web. In an implementation, funds are accessed from an account holder's mobile device such as a mobile phone or a personal digital assistant to make or receive payments. Financial transactions may be conducted on a person-to-person (P2P) or person-to-merchant (P2M) basis where each party is identified by a unique indicator such as a telephone number or bar code. Transactions may be requested through any number of means including SMS messaging, Web, e-mail, instant messenger, a mobile client application, an instant messaging plug-in application or “widget.” The mobile client application, resident on the mobile device, simplifies access and performing financial transactions in a fast, secure manner.

US 20070255620 (Tumminaro et al.; 2007 Nov. 1) Transacting Mobile Person-to-Person Payments. In a mobile payment system, registered users or members may send payment to other member or unregistered users or nonmembers. In a specific implementation, a person-to-person payment system allows existing members of a payment system to send funds to nonmembers with the intent that the nonmember becomes a member. This ability of a payment system may be referred to as “viral” because it promotes new member registrations in an exponential spreading fashion.

US 20070244811 (Tumminaro; 2007 Oct. 18) Mobile Client Application for Mobile Payments. A mobile client application executes on a mobile phone and interfaces with a mobile payment platform. A mobile payment platform and service provides a fast, easy way to make payments by users of mobile devices. The platform also interfaces with non-mobile channels and devices such as e-mail, instant messenger, and Web. In an implementation, funds are accessed from an account holder's mobile device such as a mobile phone or a personal digital assistant to make or receive payments. Financial transactions may be conducted on a person-to-person (P2P) or person-to-merchant (P2M) basis where each party is identified by a unique indicator such as a telephone number or bar code. Transactions may be requested through any number of means including SMS messaging, Web, e-mail, instant messenger, a mobile client application, an instant messaging plug-in application or “widget.” The mobile client application, resident on the mobile device, simplifies access and performing financial transactions in a fast, secure manner.

In light of the above, there is a need for apparatus that can provide Patrons an easy and quick way to tip “strangers” without actually having their contact information.

### BRIEF DESCRIPTION OF THE DRAWINGS

FIG. 1 illustrates patrons and different types of service providers in distinct and separate locales.

FIG. 2 shows a software subsystem diagram of the Gratuity Server that pictures all of its internal special purpose subsystems.

FIG. 3 illustrates a mobile application with service providers listed that are in proximity.

FIG. 4 pictures the Gratuity Server with Metrics Manager subsystem.

FIG. 5 shows the Gratuity Server with Ratings Manager subsystem.

FIG. 6 illustrates the Gratuity Server with Reports Manager subsystem.

FIG. 7 depicts the Gratuity Server with Mall Entity Manager subsystem.

FIG. 8 depicts the mobile application with screen for gratuity payment to a Service Provider.

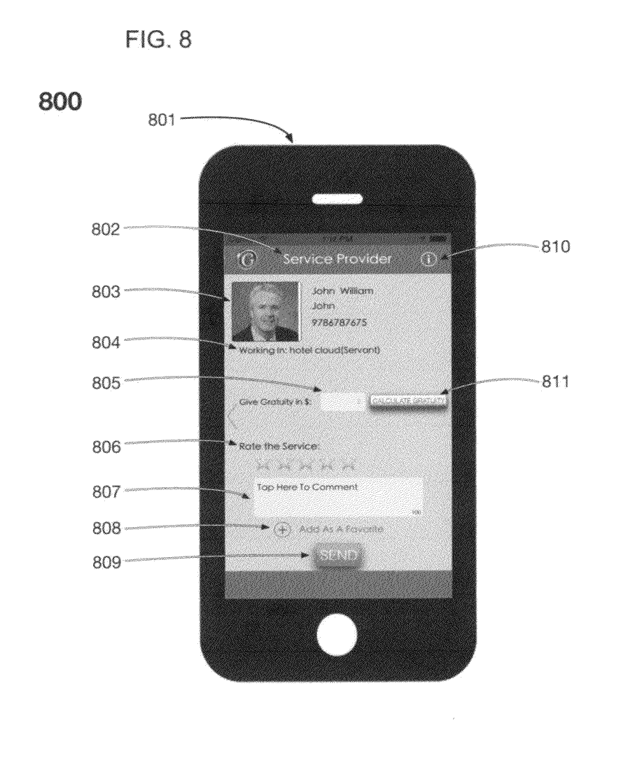

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the spirit and scope thereof. For instance, features illustrated or described as part of one embodiment may be used with another embodiment to yield a still further embodiment. Thus, it is intended that the present subject matter covers all such modifications and variations within the scope of the appended claims and their equivalents.

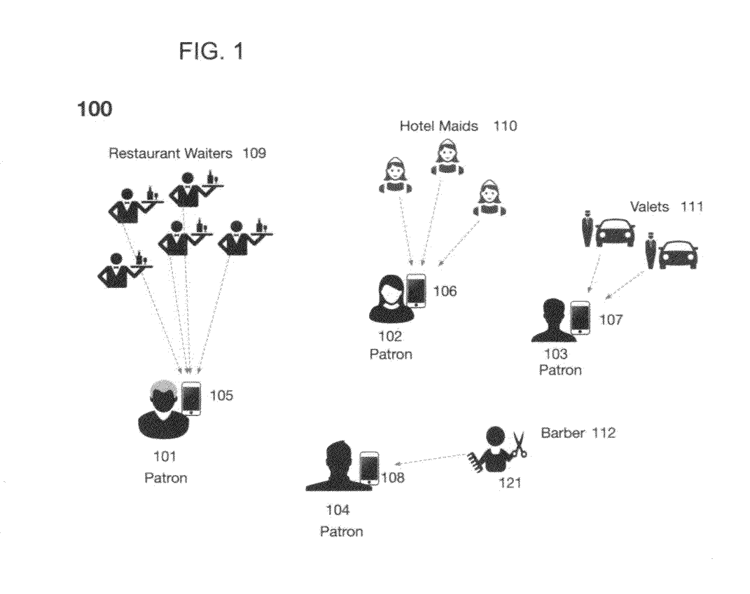

FIG. 1 illustrates four different service vicinities with associated different types of Service Providers. Each service vicinity is associated with a Service Entity such as a specific Restaurant, Hotel, or other place of business. 101 through 104 represent Patrons that are each located at each distinct vicinity with their Gratuity Mobile Applications on mobile phones (105-108), and are located at distinct Service Entities. The Service Providers (109-112) have each pre-registered an association with their Service Entity, which provides nearby Gratuity Mobile Applications (105-108) information about which Service Providers work at the Service Entity.

One embodiment of the present invention recognizes that while Service Providers are associated with a Service Entity and can be located via search of the Service Entity, the Service Providers that are listed will also include those workers not currently on duty. As such, an additional mechanism that detects that a Service Provider is actually on duty is provided by the embodiment. This may include using their phone's GPS to detect their proximity to the Service Entity or an application that actually lets them check-in to declare them as on-duty. Such an embodiment may also include a mechanism to check-out as well or use GPS to detect that they are too far away from the Service Entity to be considered on duty any more and then automatically check-out. Those familiar with the art of programming mobile phones with GPS will know how to incorporate these mechanisms.

One embodiment recognizes that not all Service Providers will be regularly detected as “on duty” but recognizes that those that are declared or discovered as being “on duty” should show up at the top of search results. A similar embodiment recognizes that “on duty” is an important status that should be marked with a tiny logo next to the Service Provider's name so it is very easy for a Patron to see that they are, in fact, “on duty”.

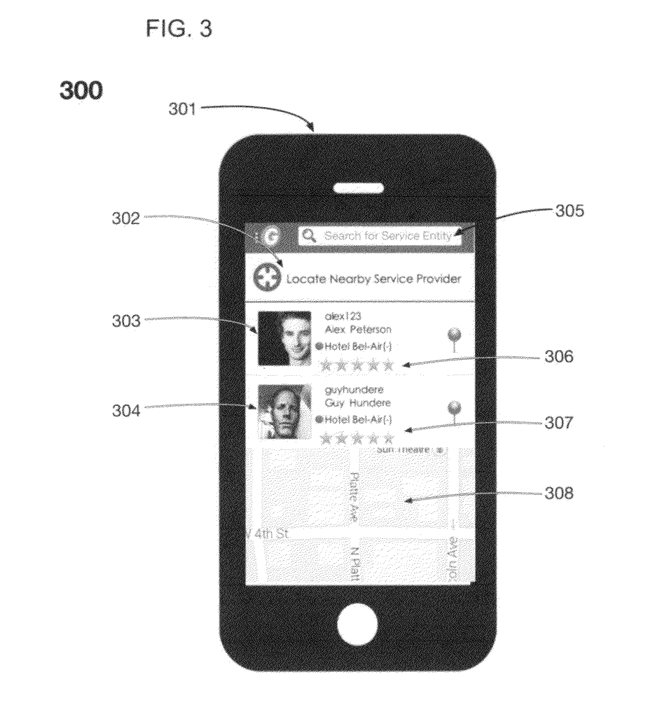

Via one of the mechanisms for proximity detection, nearby mobile phones running the Gratuity Mobile Application (105-108) will see a list of nearby Service Providers, which may include their photos to assist identification. This ability to get a list of Service Providers that are nearby so easily is a superior approach to typing in a Service Provider ID (as in FIG. 3), or even typing or selecting the Service Entity that the Service Providers work at. However, when multiple service businesses are crowded together, an additional Service Entity selection may be more necessary than usual.

While the list includes the ability for a Service Provider to show a photo for better identification, they don't have to show a photo and can have Patrons select their Service Provider ID that is printed on their badge which is globally unique. This ID can be a user ID with a real name or even a funny or weird name as many people employ for their email IDs. Similarly, a service provider could show only their photo and no friendly human readable user ID. The important thing is that there is a way for a Patron to easily identify a Service Provider in the list that they will be presented.

Service Providers are listed based on a general search but more likely based on searching for the specific Service Entity that a Patron is visiting. The search may be facilitated via a list of Service Entities that are known to be nearby the GPS recorded by a Patron's mobile phone (for example, similar to the Foursquare mobile application of 2013). A Service Entity may be selected which serves as a simple search filter for Service Providers which are then presented in a list with those known to be “on duty” at the top of the list.

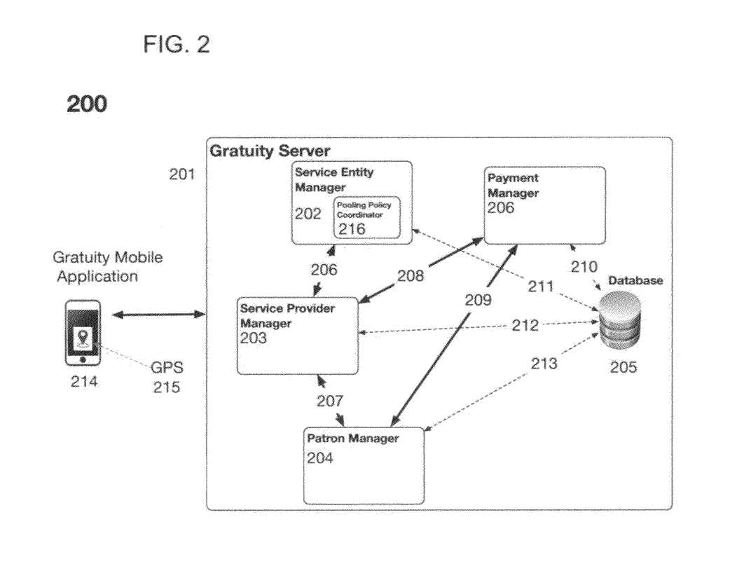

We now turn our attention to FIG. 2. When a Service Provider keyword search is submitted via the Gratuity Mobile Application (214) to the Service Provider Manager (203), the matching Service Provider names, which are indexed via one of the common text index subsystems (e.g. Lucene) are returned and sent back with their unique Service Provider Ids to the Gratuity Mobile Application (214). This can be with “on duty” attributes or not. When a Service Entity-centric search is submitted via the Gratuity Mobile Application (214), the single Service Entity typed or selected is submitted to the Service Entity Manager (202) which answers with the list of Service Providers associated with the establishment, and again, with those Service Providers deemed as being “on duty” at the top of the search result. The list of Service Entities can be presented based on the Patron's Mobile Device's GPS (215) which may then be employed to look up which Service Entities are nearby via the Service Entity Manager (202).

One embodiment answers Service Providers in this manner by submitting a query to the Database (205) which is a relational database wherein the query includes a SELECT clause “SELECT service_provider_names” to get the names, and a simple WHERE clause with “WHERE service_{—} entity_{—} name=ServiceEntitySelectedOrTyped”.

One embodiment answers Service Providers in this manner but ordered with those known to be on “on duty” first with an ORDER BY DESC clause with “ORDER BY on_duty DESC”.

One embodiment of the present invention marks the Service Provider when displayed with their “on duty” determination type, which is either mobile phone GPS, or check-in. Embodiments may employ other techniques. This can denote the accuracy and authenticity of the Service Provider's presence. For example, check-in will tend to provide the highest accuracy, particularly when the time of check-in is recorded and displayed.

The present invention beneficially allows Patrons to perform searches on Service Providers even when they are not nearby the Service Entity that Service Provider works for. Searches include geographic searches via map, listing a Service Entity, city, keywords, or any other means to denote a locale approximately or precisely. This beneficially provides the means for Patrons to know when a particular Service Provider is on duty that they really like. Some Patrons frequent Service Entities only for a specific Service Provider or Providers and only want to visit when the Service Provider or Providers are on duty.

One embodiment employs a Gratuity Mobile Application implementation that provides the means for Patrons to add Service Providers into “Favorites”. The “Favorites” list can be viewed and or a check box filter for “favorites only” may be employed during regular searching. A “Favorite” that shows up in a list should be marked with a small red heart.

One embodiment employs a Gratuity Mobile Application implement that provides the means for Service Providers to add Patrons into “Favorites”. When a Service Providers marks “Only Favorites see me Remotely”, then the Service Provider will not show up in lists unless the Patron is nearby. This gives better privacy from stalkers but won't be perfect since people tend to know Service Provider schedules anyhow. However, we don't want to make it easier for stalkers to know when a person is on duty if a Service Provider wants some privacy.

The Manager subsystems also perform all on-boarding operations. Patrons can register to create a new Patron account, which interacts with the Patron Manager (204). They set up their account including their payment information. They also can eventually delete their account via the Patron Manager (204) as well. All information is stored, updated, and deleted via 213 in the database (205). Similarly, Business owners or even employees (service providers) can set up a Service Entity so they can associate themselves with it in the system for searching and so that Patrons see the association to a registered business. This is done with the Service Entity Manager subsystem (202). Again, All information is stored, updated, and deleted via 211 in the Database (205). The Service Entity registration includes, but is not limited to: Service Entity Type (restaurant, massage, golf, etc.), city, state, postal code, GPS coordinate, size in maximum concurrent Service Providers.

A Service Provider can register to create a new account in one of two ways. The first way is to self-register. When registering, they can then associate their account with their Service Entity using the Service Entity Manager (202). When they want to disassociate it or delete their account, the Service Entity Manager (202) is again employed which interacts (211) with the Database (205). The Service Provider's Service Entity Association is stored via 211 in the Database (205).

The second approach to registering is that the first user, a Service Provider who makes the Service Entity, is an Administrator of the Service Entity. The Administrator can invite a person to be a Service Provider associated with their Service Entity. When the invitation is to someone without a Gratuity Server account, an email is employed to identify them and a welcome email is sent to them to register. When they register with the Gratuity Mobile Application, it interacts with the Gratuity Server's Service Provider Manager (203) to register and create the new account and Service Entity association. The account is stored via 212 in the Database (205) while the Service Entity association request routes through the Service Entity Manager (202) and via 211 to the Database (205).

A Service Entity Administrator can control and override all associations with the Service Entity and in fact select a checkbox in an Administration GUI that says whether or not to approve an association when self-requested. This avoids spurious requests for people who are not real employees. A Service Entity Administrator also has the ability to make other Service Providers as Administrators and take away this ability as well. The system will not allow there to be zero Administrators, so the last Administrator cannot remove themselves from being and Administrator.

Meanwhile, when a Patron decides to pay a gratuity to a Service Provider, the Patron Manager interacts via 209 with the Payment Manager (206) which will read stored payment information via 213 from the Database (205) as necessary depending on the payment mechanics of an embodiment. Some embodiments may incorporate its own currency in the system itself. Gratuity exchange is then done via the proprietary currency. Clearly the currency has no value unless it can be converted into and out of real currency or be employed to buy things from somewhere. Other embodiments implementation of the Payment Manager (206) will employ processing with credit card systems or Paypal. The Payment Manager (206) then can interact via 208 with the Service Provider Manager (203) to make sure that they are authentic, have real bank account, debit, or credit card information, and receive the gratuity. The account information is either stored in the Database (205) and retrieved via 212, which is then encumbered with PII concerns, or the account information is employed via the Payment Manager (206) via an external service.

One embodiment of the present invention provides the means for a Patron to mark a payment not as a gratuity but a gift. This will beneficially be recorded differently for tax purposes.

One embodiment of the present invention incorporates charitable giving. In this case, a Charity Entity account may be created via a Web Browser or the Gratuity Mobile Application by creating a Service Provider account wherein the embodiment provides the means to declare the Service Provider account as a Charity Entity. This allows the apparatus to work normally to allow the Charity to receive payments since the mechanisms are already in place for Service Providers to receive gratuity payments. When paying a charity, the payment just happens to be a donation and so the Service Provider Manager (203) marks all payments to the Charity as such. However, the Service Provider Manager (203) is augmented with the ability to store each Service Provider's Charity list in the Database (205) and how much to give each charity in the list.

One embodiment of the present invention provides the means for a Service Provider to set up a gratuity portion to donate based on an amount or percentage of each gratuity they receive to be sent to a designated charity of their choice. The Donation Management GUI associated with this ability of the Service Provider Manager (203) may also provide a means to declare multiple charities and allocate different amounts or ratio of the gratuity portion to donate to each charity.

One embodiment of the present invention recognizes that some Service Entities “pool” tips and then distribute them to the Service Providers at the end of a shift. The Pooling Policy Coordinator (216) is a subsystem in such an embodiment that is part of the Service Entity Manager (202). A Pooling Policy Management GUI is accessible only to a Service Entity Administrator and it provides the means to create a shift, which Service Providers are on the shift (either manually or automatically via one of the “on duty” determination mechanisms). More importantly, the GUI, provides the means with the help of the Pooling Policy Coordinator (216), to define the distribution policy, which may be equal distribution, or ratio distribution where some Service Providers get higher payouts relative to everyone else. The higher payout rate will beneficially allow pooling but also recognize who on a shift is more senior and/or generally works a more difficult role in the business and therefore is due a higher payout rate. While all Patron gratuity payments are made to specific Service Providers, the payments are instead “intercepted” via 206 and pooled by the Service Entity that has such a pool configured with the Pooling Policy Coordinator (216). The embodiment clearly presents the payouts that have been computed and will be done at the end of a shift along with a “Confirm” button for the “Pool Distribution”. Once the Service Entity Administrator pushes the button, the gratuity payouts from the shift pool are transferred to their individual Service Provider accounts via the Service Entity Manager (202) interacting with the Service Provider Manager (203) to transfer funds to the individual Service Provider accounts based on the Pool Distribution.

An embodiment may incorporate a Pooling Policy Management GUI that supports many other pooling policies.

One embodiment of the present invention provides a Pooling Policy Management GUI and associated Pooling Policy Coordinator (216) with the means to override a Pool Distribution wherein the Service Entity Administrator can make small payment adjustments to a Pool Distribution in order to correct for small perturbations that may happen during a shift. Small perturbation example include one Service Provider coming late to a shift, leaving early from a shift, breaking equipment or tools, or any other reason that a Service Entity Administrator may deem worthy of a small adjustment to one or more Service Providers on a shift for a “fair” Pool Distribution.

FIG. 3 depicts the salient portion of the Gratuity Mobile Application (301) graphical user interface that shows the list of nearby Service Providers at the Service Entity selected “Hotel Bel-Air”. A button (302) may be pressed to activate the discovery of proximal Service Providers as shown in the figure. Some embodiments may obviate the need for a button by just updating in real-time continuously.

Once nearby Service Providers are ready to be listed, their user IDs and photos are displayed (303 and 304). As alluded to earlier, however, Service Provider accounts will have privacy controls to enable and disable photos, names, and user IDs. Service Providers must realize, however, that they perform a public function and can't be completely private or they won't be able to be identified. As shown by 306 and 307, an embodiment may also depict the current rating of a Service Provider. A map location (308) may be depicted as well.

In a typical embodiment, a simple keywords filter field (305) is also available to refine search results further. Again, the benefit of Service Providers employing GPS or a check-in mechanism with the Gratuity Mobile Application (301) is that the Service Providers listed are likely to be already refined well enough. However, as mentioned some Service Entities conduct business in malls or other crowded buildings or areas and so on duty Service Providers from distinct Service Entities will appear as nearby results. The filter field (305) can assist to refine results better. Some embodiments may choose to provide a select filter that shows only Service Entities that are nearby, thus making it even easier to refine results in crowded Service Entity vicinities.

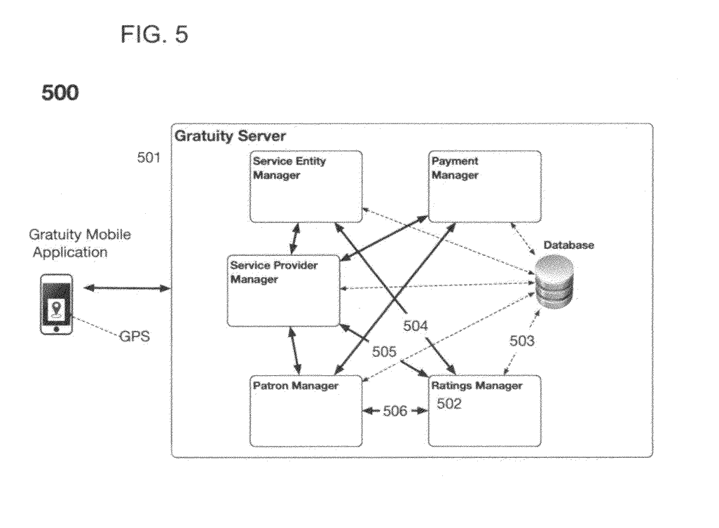

Once a Service Provider is selected from the list for giving a gratuity (for example, by selecting the list item, a location on the list item, or a swipe), the gratuity giving screen (802) of mobile phone (801) application is presented as shown in FIG. 5. Here the profile allowed to be displayed, based on the Service Provider's privacy settings, is presented for the Service Provider selected. The Service Entity that the Service Provider is “on duty” at is also listed (804). The gratuity amount may be entered in an input box (805). Some embodiments that integrate with the transaction accounting system of the business can know the current cost of the transaction wherein the “calculate gratuity” button (811) can provide a suggested amount. The Patron can also select the number of stars from 1 through 5 as a means to rate the Service Provider. This will be recorded in embodiments supporting a Ratings Manager (502) as shown in FIG. 5. Along with a rating, a comment may be added in a large input box (807). The Service Provider may be added as a favorite with one touch of a button (808). Finally, when the Patron is ready to pay the gratuity and confirm it, they press “SEND” (809) or some other similar confirming button. The (i) button (810) is available to provide helpful information for how to use the screen.

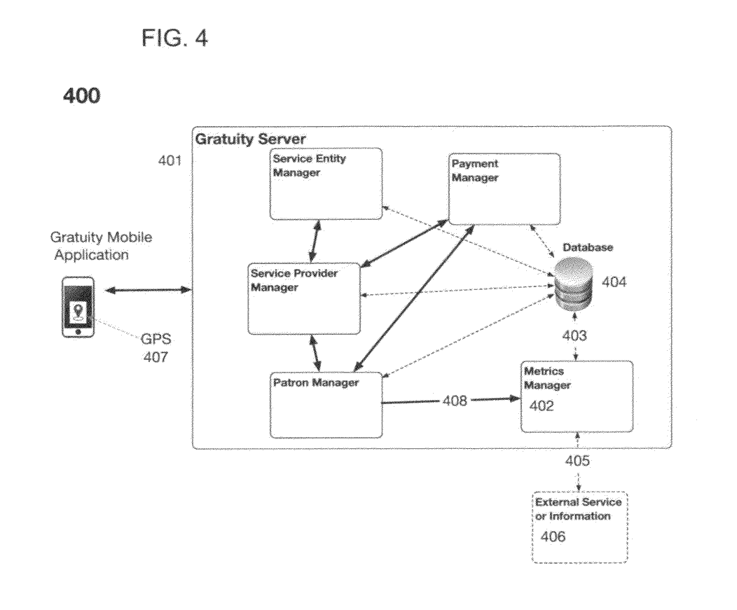

One embodiment of the present invention augments the Gratuity Server with the ability for computation of interesting metrics. Such augmentation is pictured in FIG. 4 wherein the Gratuity Server (401) now includes a Metrics Manager (402). The Metrics Manager comprises an autonomous Daemon process that runs periodically to calculate the metrics and store them (403) in Metrics Tables in the Database (404). Some metrics use external services (406) to retrieve additional information that may also be integrated and stored.

One embodiment of the present invention provides a Metrics Management GUI for the Service Provider so that they can view their average tips and graph how they've trended up or down on an hourly, daily, weekly, monthly, or even yearly basis and percentage of invoice (if known). Additionally, Service Providers working two or more jobs will have separate GUI pages for each distinct Service Entity that they work at and also have a composite page for comparing gratuities between the jobs.

One embodiment of the present invention also computes for a Service Provider, the average per hour gratuity at each Service Entity they work for as well as showing a time of day distribution of these averages. This will beneficially let them know which hours during the day they do better on gratuity per hour rate.

One embodiment of the present invention provides a Metrics Management GUI for the Patrons so that they can view their average tips and graph how they've trended up or down on a daily, weekly, monthly, or even yearly basis and percentage of invoice (if known).

One embodiment of the present invention provides a Metrics Management GUI for the Service Entity Administrators so that they can view their associated Service Provider average tips and graph how they've trended up or down on a daily, weekly, monthly, or even yearly basis and percentage of invoice (if known). The GUI includes the ability to also present and graph the aggregate of all Service Provider statistics.

Those familiar with the art of recording payment transactions and retrieving the information for various statistics computation will know how to calculate various statistics on the transactions and then display the information when requested.

For example, one embodiment of the present invention computes average gratuities including gratuity percentages.

One embodiment of the present invention retrieves average gratuity information from an external information source on the Internet (406).

One embodiment of the present invention computes (402) and stores (403, 404) the average gratuities and percentages per Service Entity Type and per city, state, and postal code.

One embodiment of the present invention computes (402) and stores (403, 404) average gratuity and gratuity percentage per individual Service Entity.

One embodiment of the present invention computes (402) and stores (403, 404) average gratuity and gratuity percentage per individual Service Provider.

One embodiment of the present invention tracks in real-time, a Patron's GPS (407) coordinate and is able to compute and store an ETA in the Metrics Manager (408) for their arrival to a Service Entity that the Service Provider there may view if privacy settings of the Patron expected to arrive allow.

FIG. 5 depicts the Gratuity Server (501) again but this time with a Ratings Manager (502) that provides the means for Patrons to rate both individual Service Providers as well as Service Entities when they pay a gratuity. The rating system may employ any means to indicate a gray scale of dismal to excellent. Some examples are 1 to 5, but could also be 1 to 10, or some other system using colors, or virtual badges, or quantity of stars or color of stars. An embodiment may also include the ability to add a comment to a rating.

One embodiment of the present invention attempts to realize strictness by making sure that the rating for a Service Provider or Service Entity by a Patron may only be performed within a recent number of hours or days of the Patron actually having recorded GPS coordinates nearby the Service Entity in question.

One embodiment of the present invention attempts to realize strictness by making sure that the rating for a Service Provider or Service Entity by a Patron may only be performed within a recent number of hours or days of the Patron actually having recorded GPS coordinates nearby the Service Entity in question and the Service Provider is proven to have been “on duty” at the same time.

One embodiment presents ratings information as a number or visual icon (for example, stars) next to a Service Provider and next to a Service Entity when they show up in a list on the Gratuity Mobile Application.

One embodiment provides the means for Service Entity Administrators to look up on a Ratings Management GUI what rating scores their associated Service Providers have been receiving as well as their average scores and ratings history.

Service Providers may look up their own rating on a Ratings Management GUI for themselves that displays a history of their ratings (time, patron, score, and comment) as well as their average score and the average score of the Service Entity they belong to.

One embodiment of the present invention allows a Service Provider to look at a graph of their ratings against their peer Service Providers and also look at a summary of their average rating-compared to the average rating, min rating, and max rating of their peers at the same Service Entity.

One embodiment of the present invention provides the means to allow the Service Provider to press a button on the Ratings Management GUI page in order to send an email that links back to their rating page so that they can provide an authenticated “resume” of their ratings when looking for a job.

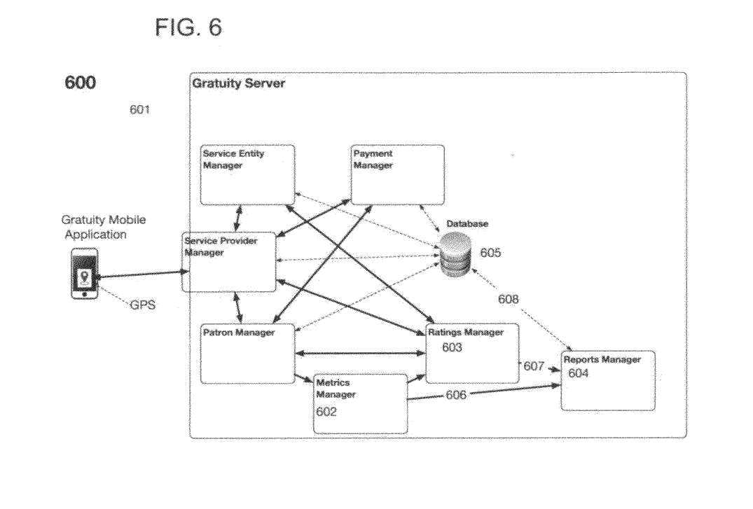

FIG. 6 illustrates the Gratuity Server 601 augmented further with a Reports Manager (604) that enables an embodiment to generate nicely formatted pages containing information of interest. More specifically, a report can be, but is not limited to: PDF file, Excel or Google Spreadsheet, or HTML Web Page. Reports are very similar to the GUI screens presented earlier for metrics and ratings but are better formatted for long many page presentation. For example, one embodiment organizes the pages nicely by having a Report Title page followed by a Table of Contents page with links to the actual pages, thus providing a nice overview of the Report with an easy way to navigate to specific pages of charts, grids, and lists.

As shown in FIG. 6, the Reports Manager (604) reads (606 and 607) from the subsystems that are collecting and calculating interesting information such as the Metrics Manager (602) and Ratings Manager (603) and stores (608) Reports in the Database (605) so they may be retrieved later. The Reports Manager (604) therefore reads all of the possible metrics generated by the Metrics Manager (602) and the Ratings statistics from the Ratings Manager (603) in order to produce the same charts, graphs, grids, and lists that are presented in the corresponding Metrics Management GUI and Ratings Management GUI presented earlier.

One embodiment of the present invention allows Service Providers, Patrons, and Service Entity Administrators to configure a schedule for receiving a PDF or link to web page in email for a Report configured to periodically provide the information they are interested in.

One embodiment of the present invention provides the means for a Service Provider to generate a report suitable for tax or compensation proof purposes (such as loan acquisition), authenticating the details of gratuity compensation received in the past and for a calendar year. The report will, of course, understand which payments were marked as gifts and not include that as part of the compensation.

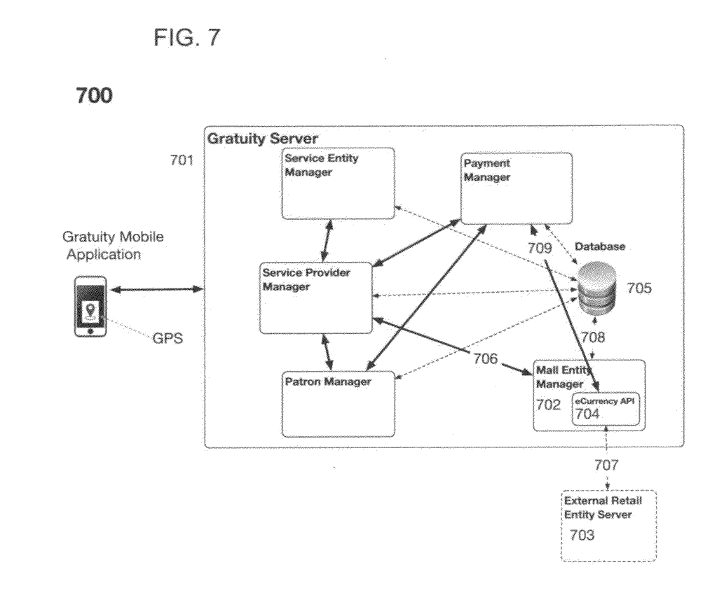

FIG. 7 extends the Gratuity Server with a Mall Entity Manager (702) which provides the means for any Retail Entity to register their presence with the Gratuity Server in an online Mall and integrate payment for their retail products or services with “Gratuity Server Currency”, “Points”, or “Credits”. An External Retail Entity Server (703) employs the Mall Entity Manager's (702) eCurrency API (704) to retrieve Credits from the Database (705) via 708 for a specific Service Provider's purchase on their site. The Service Provider must have been pre-authenticated via common OAuth 2 procedure. At some later point, the eCurrency API is again employed by an External Retail Entity Server (703) to request actual payment, via 709 to the Payment Manager, based upon an agreed conversion price per Credit. This additional manager subsystem beneficially provides Retailers with a new channel for advertising and purchase. They can even increase desire to purchase by offering discounts for Service Providers that use their Credits.

One embodiment of the present invention provides the means for a Retail Entity to allocate an image for their logo, but also an image and/or wording for an advertisement, potentially for payment. A Mall Entity Management GUI that they have access to would make this possible.

Service Providers will be encouraged to employ their Credits for purchases via reminders and advertisements on the side of the core part of the Gratuity Mobile Application that are retrieved via 706. The Service Providers would be able also to browse Retailers available in the Mall where they can buy things from and then click to navigate to the retail website and browse products and services.

The retail website must employ their own Retail Servers (703) to interact with the Mall Entity Manager's (702) eCurrency API (704) to actually deduct Credits and collect real currency payments.

One embodiment of the present invention provides the means for a Mall Entity Retailer to generate reports on purchase history via Gratuity Server Currency so they can monitor how well this gratuity channel works for them.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention, which is more particularly set forth in the appended claims.

What is claimed is:

1. A networked and distributed environment with a mobile phone application and gratuity server which together execute a computer implemented method across these distributed subsystems, the computer-implemented method comprising:
a mobile phone application providing the means to search for service providers;
a service provider manager on the gratuity server for receiving the search details and returning results of the search back to the mobile phone application;
a mobile phone application providing displaying all of the search results obtained in a list of the service providers including their globally unique IDs;
a mobile phone application providing selection of one of the service providers;
a mobile phone application providing the ability to enter a monetary amount to pay the selected service provider;
a payment manager on the gratuity server for receiving a globally unique patron ID, globally unique service provider ID, and gratuity amount in order to transfer funds from the patron ID to the service provider ID.
a gratuity database that stores service provider account information including financial information to collect funds, patron account information including financial information to make payments, as well as payment history.

2. The system of claim 1 further comprising a service entity manager on the gratuity server that manages service entity information including:
GPS coordinate of the service entity;
list of service providers associated with the service entity.

3. The system of claim 2 further comprising:
a mobile phone application that reads the GPS coordinate of the mobile phone;
a service entity manager on the gratuity server for receiving the search details wherein the details include the GPS coordinate and returning results of the search wherein the list of service providers is ordered by their distance that their service entity's distance is from the GPS coordinate received.

4. The system of claim 2 further comprising:
a mobile phone application providing the means to search for service providers by typing in a service entity name;
a service entity manager on the gratuity server for receiving the service entity name and returning results of the search wherein the list of service providers are only the ones associated with the service entity.

5. The system of claim 2 further comprising:
a mobile phone application that reads the GPS coordinate of the mobile phone;
a service entity manager on the gratuity server for receiving the search details wherein the details include the GPS coordinate and returning results of a search for service entities wherein the list of service entities is ordered by their distance that their distance is from the GPS coordinate received;
a mobile phone application that displays the list of service providers associated with a selected service entity.

6. The system of claim 2 further comprising:
a mobile phone application that provides the means for a service provider to check-in to their associated Service Entity in order to declare themselves as on-duty;
a service provider manager that receives the on-duty status change for a service provider ID and then stores this status update in a database;
a service provider manager that returns service provider search results wherein the service providers that are declared as on-duty are so marked in the results;
a mobile phone application that displays the list of service providers with those that are declared on-duty first in the list.

7. The system of claim 2 further comprising:
a mobile phone application that reads the GPS coordinate of the mobile phone;
a service provider manager that receives the GPS coordinate for a service provider ID and if the service provider is found to be within a very short-distance of their associated service entity they are declared to be on-duty and then stores this status update in a database;
a mobile phone application that displays the list of service providers with those that are declared on-duty first in the list.

8. The system of claim 1 further comprising:
a mobile phone application that provides the ability for a patron to add one or more service providers to a list of favorites;
a patron manager that receives a globally unique patron ID and list of service provider IDs to add to the patron's favorites list.
a service provider manager that is further extended to receive a patron ID with a search request and with this patron ID looks up the patron's favorites and returns the search results with the service providers that are favorites, marked as such.

9. The system of claim 1 further comprising:
a mobile phone application that provides the ability for a patron to mark a payment to a service provider as a gift rather than a gratuity;
a service provider manager that stores payment history and marks whether the payment is a gratuity or a gift.

10. The system of claim 1 further comprising:
a mobile phone application that provides the ability for a charity organization to create a service provider account for itself and mark it as a charity;
a service provider manager that marks all payments to the charity as a gift.

11. The system of claim 10 further comprising:
a mobile phone application that provides the ability for a service provider to select charities they want a portion of their received gratuities to go to and declare how much to be given to each charity upon each received gratuity;
a service provider manager that interacts with the payment manager to transfer the pre-allocated donation amounts to the specified charity organizations.

12. The system of claim 2 further comprising:
a pooling policy management GUI that allows a service entity administrator to configure how a shift will pool and distribute collected gratuities;
a service provider manager that intercepts gratuities that are submitted to service providers that are in a shift with pooling policy and sends the gratuity to be aggregated to the service entity manager so that the service entity with the pooling policy can aggregate the gratuities to be distributed at the end of a shift;
a pooling policy management GUI that, at the end of a shift, presents the distribution of funds that will be transferred to each service provider in the shift based on the pooling policy and doesn't perform the transfer until the service entity administrator presses a “confirm” push button on the pooling policy management GUI.
a service entity manager that performs the individual payments based on the pooling policy distribution approved.

13. The system of claim 2 further comprising a pooling policy management GUI that allows a service entity administrator to make fine adjustments of payments to the individual service providers before confirming a pool distribution.

14. The system of claim 1 further comprising a metrics manager that interacts with the Database to compute and store statistics such as per service provider gratuity averages, per service provider hourly rates, minimums, maximums, and standard deviations for various time periodicities.

15. The system of claim 14 further comprising a metrics manager that provides the means to return hourly rates in a time of day distribution.

16. The system of claim 2 further comprising a metrics manager that interacts with the Database to compute and store statistics such as per service entity gratuity averages, per service entity hourly rates, minimums, maximums, and standard deviations for various time periodicities.

17. The system of claim 1 further comprising:
a mobile application that provides the means for a patron to enter a rating of the service provider along with a gratuity payment to the service provider;
a ratings manager that stores the ratings history of each service provider in the database.

18. The system of claim 1 further comprising:
a mobile application that provides the means for a patron to enter a rating of the service provider's service entity along with a gratuity payment to the service provider;
a ratings manager that stores the ratings history of each service entity in the database.

19. The system of claim 17 further comprising a metrics manager that interacts with the ratings manager to compute per service provider rating averages and standard deviations for various time periodicities.

20. The system of claim 17 further comprising a metrics manager that interacts with the ratings manager to compute per service entity rating averages and standard deviations for various time periodicities.

21. The system of claim 19 further comprising the ability for a service provider to send an email to a specified email address with a link to a page presenting their ratings statistics.

22. The system of claim 19 further comprising the ability for a service provider to compare themselves with other service providers in the same service entity.

23. The system of claim 14 further comprising a reports manager that provides the means for a service provider to get a calendar year summary document of their gratuity compensation including total for the year as well as monthly.

24. The system of claim 1 further comprising:
a mall entity manager that provides the means for a retail entity to register in an online mall;
a mobile application that displays a representation of retail entities registered with their website;
an eCurrency API providing the means for an external retail entity server to debit a service provider ID's account based on a purchase they do at the retail website after the service provider authenticates via OAuth 2 with the server representing the invention.
an eCurrency API providing the means for the retail entity to request actual payment of all unredeemed service provider account debits.
